(19) United States
(12) Patent Application Publication
(10) Pub. No.: US 2022/0014688 A1
(43) Pub. Date: Jan. 13, 2022

(54) IMAGE PROCESSING METHOD AND DISPLAY DEVICE THEREOF

(71) Applicant: SAMSUNG ELECTRONICS CO., LTD., Suwon-si, Gyeonggi-do (KR)

(72) Inventors: Kilsoo CHOI, Suwon-si (KR); Dahee JEONG, Suwon-si (KR)

(73) Assignee: SAMSUNG ELECTRONICS CO., LTD., Suwon-si, Gyeonggi-do (KR)

(21) Appl. No.: 17/291,716

(22) PCT Filed: Oct. 30, 2019
(86) PCT No.: PCT/KR2019/014475

§ 371 Date: May 6, 2021

(30) Foreign Application Priority Data
Nov. 8, 2018 (KR) 10-2018-0136807

(51) Int. Cl. H04N 5/262

(52) U.S. Cl. CPC H04N 5/2628

(57) ABSTRACT

Provided is a display apparatus that obtains first information regarding an image type of a source image, determines, based on the first information, whether the source image is a first-type image that has to be entirely displayed or a second-type image that is partially displayable, converts the source image into a display image corresponding to the irregular display region, based on the determining, and displays the display image.

### TECHNICAL FIELD

An embodiment of the present disclosure relates to an image display method in a display apparatus and the display apparatus corresponding to the image display method.

More specifically, an embodiment of the present disclosure relates to an image display method in a display apparatus having an irregular display region and the display apparatus corresponding to the image display method.

### BACKGROUND ART

Display apparatus has functions of displaying images that users may watch. For example, in the past, a display apparatus unidirectionally receives a broadcast signal broadcast by a broadcasting station and displays a broadcast image. However, a current display apparatus provides a function of outputting various image contents as well as a broadcast image provided from a broadcasting station.

In addition, with the development of a display apparatus, the display apparatus has been used not only at home, but also in a situation control room of a police station, a fire station, a weather center, a military base, etc., and as a video wall, etc., that provides advertisement and guidance information in a shopping mall lobby, etc. Herein, a video wall, which is one large-scale display in which a plurality of displays are coupled, is a display made by modularizing the plurality of displays.

In addition, as display apparatuses have been developed, a large-scale display such as a large format display (LFD) has been developed and spread. Moreover, with the development of display apparatuses, a display with a display panel having an irregular form has been developed as well as a display having an existing rectangular form with a general aspect ratio, e.g., 4:3, 16:9, 2:1, etc. Even a modularized display such as a video wall has also been developed to have an irregular form as well as an existing rectangular form with a general aspect ratio, e.g., 4:3, 16:9, 2:1, etc. That is, a display apparatus having an irregular display region has been developed. Hereinafter, for convenience of explanation, a display region corresponding to a rectangular shape is referred to as ‘a regular display region’, and a display region corresponding to a shape other than a rectangular shape is referred to as ‘an irregular display region’.

However, an image included in image contents such as movies, dramas, advertisements, etc., is produced in a rectangular form with a general aspect ratio, e.g., 4:3, 16:9, 2:1, etc. A display apparatus having a general rectangular form may display an image with a general aspect ratio without strain. However, in the display apparatus having an irregular display region described above, the display region may not correspond to an image with a general aspect ratio.

Therefore, in a display apparatus having an irregular display region, a method of outputting image contents on a screen and the corresponding display apparatus need to be provided.

### DESCRIPTION OF EMBODIMENTS

### Technical Problem

An embodiment of the present disclosure provides an image display method to efficiently display an image in a display apparatus having an irregular display region and the display apparatus corresponding to the image display method.

More specifically, an embodiment of the present disclosure provides an image display method to efficiently display an image suitably for an irregular display region such that a user viewing a display apparatus does not feel uncomfortable, and the display apparatus corresponding to the image display method.

### Solution to Problem

An embodiment of the present disclosure may efficiently display an image suitably for an irregular display region such that a user viewing a display apparatus does not feel uncomfortable.

### Advantageous Effects of Disclosure

An image display method and a display apparatus corresponding thereto according to an embodiment of the present disclosure may efficiently display an image in the display apparatus having an irregular display region.

The image display method and the display apparatus corresponding thereto according to an embodiment of the present disclosure may display an image through the irregular display region such that sought image contents may be entirely provided to a user viewing the display apparatus without causing discomfort to the user.

### BRIEF DESCRIPTION OF DRAWINGS

FIG. 1 is a view for describing a display apparatus having an irregular display region;

FIG. 2 is a view for describing displaying of an image in a display apparatus having an irregular display region;

FIG. 3 is another view for describing a display apparatus having an irregular display region;

FIG. 4 is a block diagram of a display apparatus according to an embodiment of the present disclosure;

FIG. 5 is a view illustrating different image contents;

FIG. 6 is a view for describing an aspect ratio of an image outputtable on a display having an irregular display region;

FIG. 7 is another view for describing an aspect ratio of an image outputtable on a display having an irregular display region;

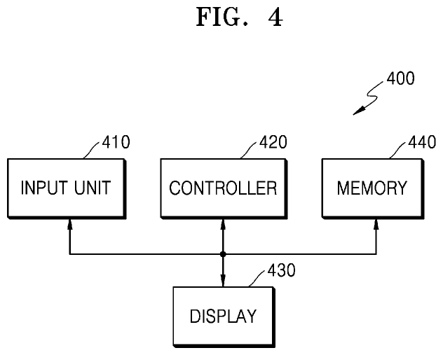

According to an embodiment of the present disclosure described with reference to FIGS. 4 through 7, a source image may be automatically displayed entirely according to whether the source image is an image that needs to be entirely displayed, thereby providing information to be provided to a viewer without a loss. Thus, a user's satisfaction may be improved. Moreover, according to an embodiment of the present disclosure, when the source image does not need to be displayed entirely, the source image may be displayed by using the display having the irregular display region in overall. As a result, aesthetic sensibility of an image output through an irregular display may be maximized. Furthermore, a region of the image output through the irregular display may be changed variously, allowing a user to feel interest in the source image while viewing the source image.

FIG. 8 is a block diagram of a display apparatus according to another embodiment of the present disclosure;

FIG. 9 is another block diagram of a display apparatus according to another embodiment of the present disclosure;

FIG. 10 is another block diagram of a display apparatus according to another embodiment of the present disclosure;

FIG. 11 is a block diagram illustrating in detail the display apparatus of FIG. 10;

FIG. 12 is a view for describing an image output operation according to an embodiment of the present disclosure;

According to an embodiment of the present disclosure described with reference to FIG. 12, when a source image is a second-type image, the source image may be displayed such that a part of the source image is not included and another part of the source image is included in an irregular display region, thereby maximizing the aesthetic sensibility of the display and thus the sense of excitement the view may feel.

FIG. 13 is another view for describing an image output operation according to an embodiment of the present disclosure; and

According to an embodiment of the present disclosure described with reference to FIG. 13, when a source image is a first-type image, the source image may be entirely displayed on an irregular display region, thereby allowing information or a meaning the source image is to provide to be provided to a viewer without any deformation or loss.

FIG. 14 is a flowchart of an image display method according to an embodiment of the present disclosure.

### BEST MODE

An image display method according to an embodiment of the present disclosure outputs an image through a display apparatus having an irregular display region. An image display method according to an embodiment of the present disclosure includes obtaining first information regarding an image type of a source image, determining, based on the first information, whether the source image is a first-type image that has to be entirely displayed or a second-type image that is partially displayable, converting the source image into a display image corresponding to the irregular display region, based on the determining, and outputting the display image through the display. According to an embodiment of the present disclosure, a source image may be automatically displayed entirely according to whether the source image is an image that needs to be entirely displayed, thereby providing information to be provided to a viewer without a loss. Thus, a user's satisfaction may be improved. Moreover, according to an embodiment of the present disclosure, when the source image does not need to be displayed entirely, the source image may be displayed by using the display having the irregular display region in overall. As a result, aesthetic sensibility of an image output through an irregular display may be maximized. Furthermore, a region of the image output through the irregular display may be changed variously, allowing a user to feel interest in the source image while viewing the source image.

A display apparatus according to an embodiment of the present disclosure may include an input unit, a display comprising an irregular display region, a memory storing at least one instruction, and a controller including at least one processor configured to execute at least one of the at least one instruction. Herein, the controller may obtain first information regarding an image type of a source image, determine, based on the first information, whether the source image is a first-type image that has to be entirely displayed or a second-type image that is partially displayable, convert the source image into a display image corresponding to the irregular display region, based on the determining, and control the display image to be output through the display.

### Mode of Disclosure

Hereinafter, embodiments of the present disclosure will be described in detail with reference to the attached drawings to allow those of ordinary skill in the art to easily carry out the embodiments of the present disclosure. However, the present disclosure may be implemented in various different forms, and are not limited to the embodiments of the present disclosure described herein. To clearly describe the present disclosure, parts that are not associated with the description have been omitted from the drawings, and throughout the specification, identical reference numerals refer to identical parts.

In the description of the embodiments of the present disclosure, when a part is “connected” to another part, the part is not only “directly connected” to another part but also “electrically connected” to another part with another device intervening in them. When it is assumed that a certain part includes a certain component, the term “including” means that a corresponding component may further include other components unless a specific meaning opposed to the corresponding component is written.

The phrase used in various parts of the present specification, such as “in some embodiments” or “in an embodiment” does not necessarily indicate the same embodiment.

Some embodiment may be represented by block components and various process operations. All or some of such functional blocks may be implemented by various numbers of hardware and/or software components which perform specific functions. For example, functional blocks of the present disclosure may be implemented by one or more processors or microprocessors or circuit elements for a specific function. In addition, the functional blocks of the present disclosure may also be implemented as various programming or scripting languages. The functional blocks may be implemented as an algorithm executed in one or more processors. Furthermore, the present disclosure may employ any number of conventional techniques for electronics configuration, signal processing and/or control, data processing and the like. The term such as a “module”, a “component”, etc., may be used broadly and may not be limited to mechanical or physical elements.

Connecting lines or connecting members between elements shown in the drawings are intended to merely illustrate functional connections and/or physical or circuit connections. In an actual device, connections between elements may be indicated by replaceable or added various functional connections, physical connections, or circuit connections.

In addition, ‘at least one of A or B’ may mean ‘A or B’ or ‘A and B’.

An embodiment of the present disclosure relates to an image display method in a display apparatus having an irregular display region and the display apparatus corresponding to the image display method.

More specifically, an embodiment of the present disclosure may include any type of a display apparatus having a display region with an irregular shape and may include a single display and a plurality of displays.

To be more specific, the display apparatus according to an embodiment of the present disclosure may exist in various forms such as a television (TV) having a single display (or a single display panel), a large format display (LFD), a digital signage, a digital broadcasting terminal, a tablet personal computer (PC), a mobile phone, a computer, a laptop computer, etc. The display apparatus according to an embodiment of the present disclosure may exist in the form of a video wall having a plurality of displays (or a plurality of display panels), etc. Herein, the video wall may be formed as one display apparatus by physically combining a plurality of display panels, a plurality of displays, and/or a plurality of display apparatuses.

In addition, a source image may be formed to have a general aspect ratio, e.g., 4:3, 16:9, 2:1, etc. Herein, the source image may be data visually output through the display apparatus, and may mean an image included in content input to the display apparatus.

Hereinbelow, an ‘existing display having a rectangular form’ may mean a rectangular-form display capable of outputting an image having the above-described general aspect ratio, e.g., 4:3, 16:9, 2:1, etc., without largely deforming the image. Moreover, an ‘irregular display region’ may mean a case where the entire display region has an irregular form such as a circular form, an oval form, a triangular form, a flower form, a cloud form, a pentagonal form, etc., instead of a rectangular form. The ‘irregular display region’ may also include a case where even when the entire display region has the rectangular form, the rectangular form does not correspond to the general aspect ratio, e.g., 4:3, 16:9, 2:1, etc. For example, the ‘irregular display region’ may also include a case where without largely deforming an image like the entire display region with a general aspect ratio of 1:5, 5:1, 7:1, 7:2, etc., the image may not be entirely output to correspond to the entire display region.

Hereinafter, the disclosure will be described with reference to the accompanying drawings.

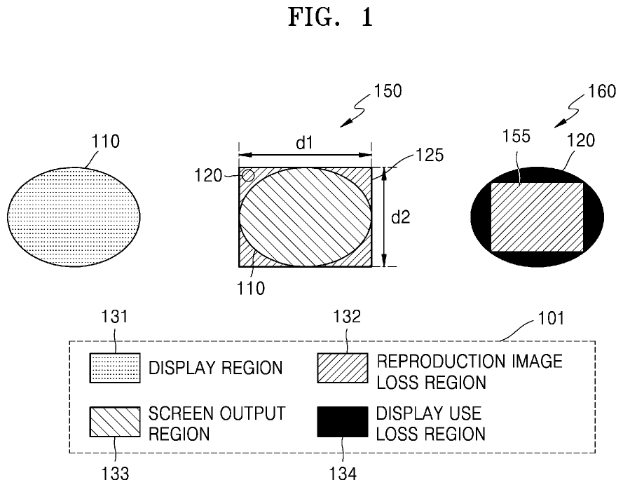

FIG. 1 is a view for describing a display apparatus having an irregular display region.

Referring to FIG. 1, the display apparatus may include an irregular display region 110. More specifically, a case where the display apparatus has an irregular display region 110 may include a case where a display panel of the display apparatus has an irregular form, a case where a region output from an image has an irregular form even if the display panel is rectangular, etc.

In FIG. 1, a case where the display apparatus has the display region 110 having an oval form is illustrated as an example. For example, a description will be made of an example where the display panel of the display apparatus is formed in an oval form.

Moreover, throughput the specification, a ‘display’ may mean not only a single display formed with one display panel, but also a display when one display apparatus is implemented by combining a plurality of displays (or a plurality of display panels or a plurality of display devices) physically separated like a video wall.

Referring to a block 101 of FIG. 1, a dotted display region 131 may mean the entire display region of the display apparatus, a downward-left dashed display region 132 may mean a region from which a meaningful screen is output, and a downward-right dashed display region 133 may mean a region in which an image is lost. A black display region 134, which is a display use loss region on which a meaningful image is not displayed on the display, may mean a region that is not used for the display to output the image.

Referring to FIG. 1, the display region 110 of the display apparatus has an oval form. In addition, a case where a source image has an aspect ratio of 4:3 and a ratio of a major axis d1 of an oval of the display region 110 to a minor axis d2 of the oval is 4:3 will be illustrated as an example.

Referring to 150, by matching an image 125 with the display region 110 as illustrated, the image 125 may be displayed. In this case, an image loss region, like a region 120, which is not displayed, may be generated among regions included in the image 125.

Referring to 160, by matching an image 155 with the display region 110 as illustrated, the image 155 may be displayed. That is, to avoid generation of a non-displayed region among regions included in the image 155, the image 155 may be displayed such that the entire region of the image 155 is included in the display region 110. In this case, like the black display region 134 in the display region 110, the display use loss region 134 may be generated in which a meaningful screen is not output. The size of the output image 155 may also be reduced.

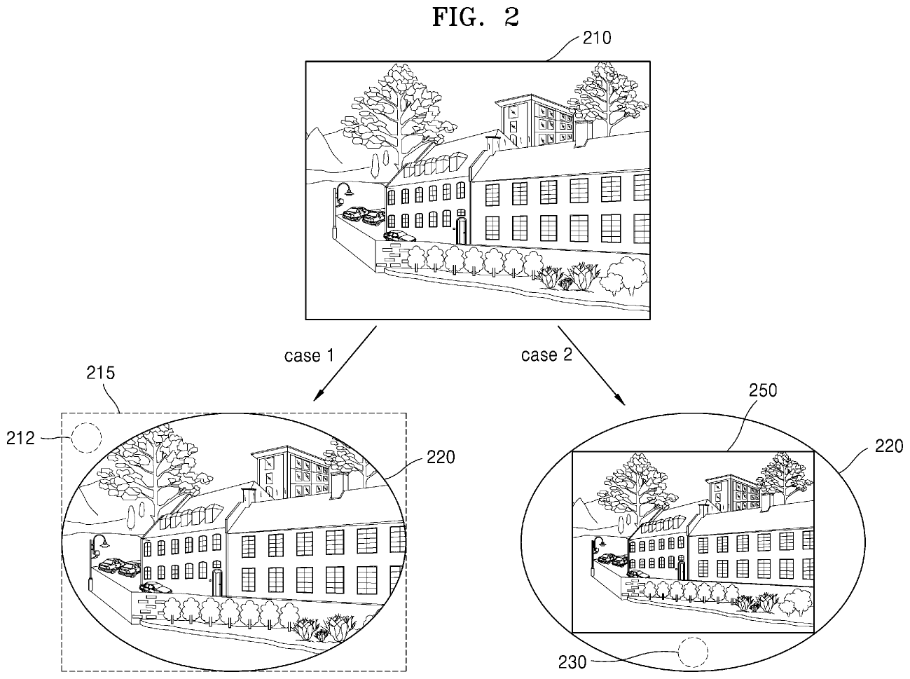

FIG. 2 is a view for describing displaying of an image in a display apparatus having an irregular display region.

An existing display apparatus determines a form, such as the shape, size, etc., of an image to be displayed using a window. The window generally has a fixed form.

Referring to FIG. 2, to output a source image 210 through a display having an irregular display region 220, there may be two cases: Case 1 and Case 2.

In Case 1, a window 215 is configured larger than the irregular display region 220. That is, Case 1 may correspond to a case where the window 215 is configured such that a part of the source image 210 is displayed. Case 1 may correspond to a case indicated by 150 of FIG. 1. In this case, the source image 210 is matched to the window 215, such that an image of a region corresponding to the region 212 in the source image 210 may not be displayed.

When the image of the region corresponding to the region 212 in the source image 210 is used to provide meaningful content to the user, the user may not be able to recognize the meaningful content.

In Case 2, the window 250 is configured to be included in the irregular display region 220. That is, Case 2 may correspond to a case where the window 250 is configured such that the entire source image 210 is displayed. Case 2 may correspond to a case indicated by 160 of FIG. 1. In this case, the source image 210 is matched to the window 250, such that in the display region 220, a region may exist like a region 230 where a display use loss occurs. As a result, the use efficiency of the display region 220 may decrease.

Therefore, when a region of the source image 210 to be output through the display region 220 is determined by using a fixed window as in the related art, a region may be generated where the source image 210 is not displayed at all times, or a display use loss region may be generated at all times.

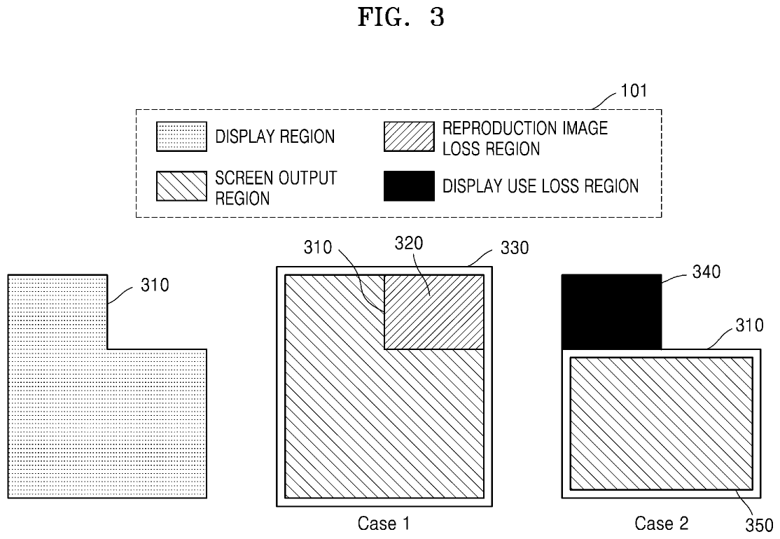

FIG. 3 is another view for describing a display apparatus having an irregular display region. In FIG. 3, the same component as in FIG. 1 is illustrated using the same reference numeral.

Referring to FIG. 3, the display apparatus may include a display region 310 having an irregular polygonal form.

Referring to FIG. 3, to output a source image through a display having an irregular display region 220, there may be two cases: Case 1 and Case 2.

In Case 1 of FIG. 3, a window 330 is configured larger than an irregular display region 310. That is, Case 1 may correspond to a case where the window 330 is configured such that a part of the source image is displayed. Case 1 of FIG. 3 may correspond to Case 1 of FIG. 2. In this case, in the source image, an image of a region corresponding to a region 320 may not be displayed.

In Case 2 of FIG. 3, a window 350 is configured to be included in the irregular display region 310. That is, Case 2 may correspond to a case where the window 350 is configured such that the entire source image is displayed. Case 2 of FIG. 3 may correspond to Case 2 of FIG. 2. In this case, in the source image 310, a region may exist like a region 340 where a display use loss occurs. As a result, the use efficiency of the display region 340 may decrease.

As described above, in a display apparatus having an irregular display region, when a fixed window is used, a reproduction image loss region may be generated at all times or a display use loss region may be generated at all times.

In an embodiment of the present disclosure, to overcome problems described with reference to FIGS. 1 through 3, the entire source image or a part thereof may be displayed through an irregular display region based on an image type of the source image. Thus, in an embodiment of the present disclosure, a part of a meaningful image that needs to be provided to the user may be prevented from being lost without being displayed, thereby improving a user's satisfaction and efficiently outputting the image through the display apparatus. With reference to FIGS. 4 through 14, an image display method and a display apparatus corresponding thereto according to an embodiment of the present disclosure will be described in detail.

FIG. 4 is a block diagram of a display apparatus according to an embodiment of the present disclosure.

Referring to FIG. 4, a display apparatus 400 according to an embodiment of the present disclosure may include an input unit 410, a controller 420, a display 430, and a memory 440.

As described above, the display apparatus 400 may include any type of a display apparatus having a display region with an irregular shape and may include a single display and a plurality of displays.

The display apparatus 400 may receive image data from the outside and output a screen corresponding to the received image data.

The input unit 410 may receive the image data from the outside. More specifically, the input unit 410 may receive image data output from a broadcasting station, image data received through an Internet network, image data provided from a certain server, image data stored in a storage device (e.g., a memory device such as a universal serial bus (USB), etc.), etc. Herein, the image data may correspond to certain content, and may include at least one of audio data for outputting auditory data or video data for outputting visual data.

The input unit 410 may include a broadcasting reception module, a short-range communication module (e.g., a wireless local area network (LAN)), wireless fidelity (WiFi), Bluetooth, near field communication (NFC), etc.), a wired communication module (e.g., a pair cable, a coaxial cable, an optical fiber cable, etc.), a mobile communication module, a wired communication module, a data input/output port such as a USB port, etc., which are capable of transmitting and receiving certain data via wired and wireless networks.

The display 430 may have the irregular display region 110, 220, or 310 as shown in FIGS. 1 through 3.

As described above, an ‘irregular display region’ may mean a case where the entire display region has an irregular form such as a circular form, an oval form, a triangular form, a flower form, a cloud form, a pentagonal form, etc., instead of a rectangular form. The ‘irregular display region’ may also include a case where even when the entire display region has the rectangular form, the rectangular form does not correspond to the general aspect ratio, e.g., 4:3, 16:9, 2:1, etc. Moreover, a ‘display’ may mean not only a single display formed with one display panel, but also a display when one display apparatus is implemented by combining a plurality of displays (or a plurality of display panels or a plurality of display devices) physically separated like a video wall.

The memory 440 may store at least one instruction. One or more instructions stored in the memory 440 may be executed through a processor (not shown) included in the controller 420.

The memory 440 may include a storage medium of at least one type of a flash memory type, a hard disk type, a multimedia card micro type, a card type memory (e.g., a secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, an optical disk, or the like.

According to an embodiment of the present disclosure, the memory 440 may store image data received through the input unit 410. The memory 440 may store image data graphically processed to be output on the display 430.

The controller 420 may include at least one processor (not shown) for executing one or more instructions. Herein, each of at least one processor (not shown) may perform a certain operation by executing at least one of the one or more instructions stored in the memory 440.

Herein, each of at least one processor (not shown) may perform a certain operation by executing at least one of one or more instructions stored in the controller 420.

In an embodiment of the present disclosure, the controller 420 may obtain first information about an image type of a source image received through the input unit 410. The controller 420 may also determine, based on the first information, whether the source image is a first-type image that has to be entirely displayed or a second-type image that is partially displayable, and convert the source image to a display image corresponding to the irregular display region. The controller 420 may also control the converted display image to be output through the display 430.

Herein, ‘entirely displaying’ may mean that the source image is displayed by being entirely included in the display 430. ‘partially displaying’ may mean that the source image is displayed such that a part of the source image is not included in the display 430 and some other part of the source image is included in the display 430.

The source image received by the controller 420 may include image data stored in the memory 440 rather than image data received through the input unit 410. Hereinbelow, a description will be made, as an example, of a case where the source image obtained by the controller 420 includes image data received through the input unit 410.

At least one processor included in the controller 420 may control operations executed in the display apparatus 400 and may control other components included in the display apparatus 400 to execute a specific operation. Thus, even when a case where the controller 420 controls certain operations to be performed is described as an example, it would be obvious that at least one processor included in the controller 420 may control certain operations to be executed.

In addition, the controller 420 may include an internal memory (not shown) and at least one processor (not shown) that executes at least one stored program. More specifically, the internal memory (not shown) of the controller 420 may store one or more instructions. The at least one processor (not shown) included in the controller 420 may perform a certain operation by executing at least one of one or more instructions stored in the internal memory (not shown) of the controller 420.

More specifically, the controller 420 may include RAM (not shown) that stores a signal or data input from the outside of the display apparatus 400 or is used as a storage region corresponding to various tasks performed by the display apparatus 400, ROM (not shown) having stored therein a control program and/or a plurality of instructions for controlling the display apparatus 400, and at least one processor (not shown). The processor (not shown) may include a graphics processing unit (GPU) (not shown) for processing graphics corresponding to video. The processor (not shown) may be implemented as a system on chip (SoC) in which a core (not shown) and a GPU (not shown) are integrated. The processor (not shown) may include a single core, a dual core, a triple core, a quad core, and multiple cores thereof.

Hereinbelow, for convenience of a description, when the controller 420 performs or controls a certain operation, a description will be made, as an example, of a case where the processor (not shown) of the controller 420 performs a certain operation by executing at least one instruction stored in the memory 440.

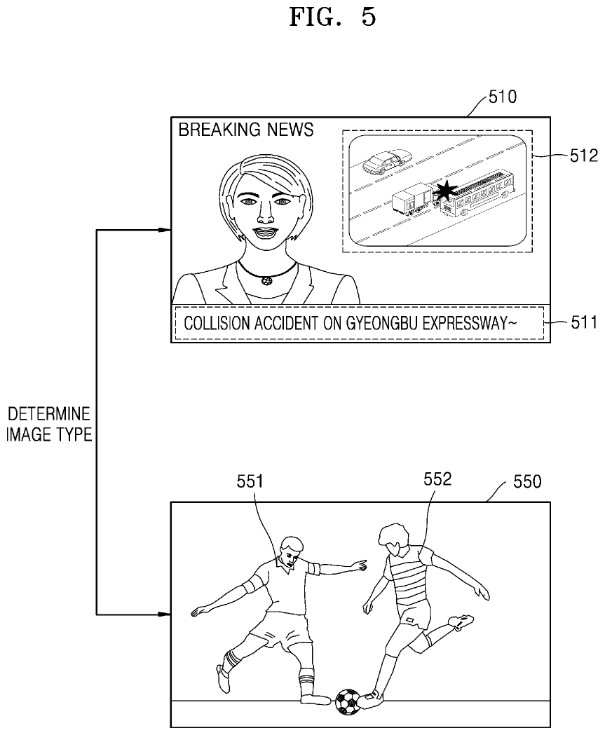

FIG. 5 is a view for describing an operation of determining types of different image contents.

The controller 420 may determine, based on first information, whether the source image is a first-type image or a second-type image. Herein, the first-type image may mean an image that has to be entirely displayed. The first information may include at least one of screen analysis of the source image, a type of an application or providing device that provides the source image, a content type of the source image, or an image genre of the source image.

More specifically, the first-type image may mean an image the user needs to recognize contents of the image as a whole. That is, when a meaning or information to be provided through the source image is not correctly provided to a viewer in the case that the source image is not entirely displayed (or a part of the source image is omitted), that source image may be referred to as the first-type image. For example, the first-type image may include (i) an image including contents for providing information of the image overall, such as news, announcements, an image including subtitles for providing information on a screen, etc., (ii) an image that needs to be viewed overall such as a movie, a drama, a sports game, etc., (iii) an image requested by a producer or a provider of the image to be entirely displayed in an original form without being deformed, etc.

The second-type information may mean an image partially displayable. That is, the second-type information may be an image other than the first-type image, and may mean an image in which a meaning or information to be provided through the source image is not changed without a need to entirely display the source image. More specifically, the second-type image may mean an image in which there is no problem in provision of the meaning or the information in spite of loss of at least some region of the image.

For example, the second-type image may include (i) an advertisement reproduction image targeted at unspecified individuals, (ii) a simple background image accompanying reproduction of music broadcasting, (iii) an image including a black image (in this case, this may be an irrelevant image because of being lost when a black image part is reproduced), etc. For reference, as an image displayed accompanying reproduction of music broadcasting, a screen including lyrics corresponding to music in a subtitle form may be the first-type image. This is because the image is displayed to provide the lyrics corresponding to the music to a viewer.

More specifically, the controller 420 may analyze or recognize a source image by using an optical character recognition (OCR) method, an automatic content recognition (ACR) method, etc. The controller 420 may determine whether the source image is the first-type image or the second-type image, based on the analyzed or recognized screen.

FIG. 5 is a view illustrating different image contents.

Referring to FIG. 5, the controller 420 may determine an image type of the source image. Referring to FIG. 5, when the source image is a news image, the controller 420 may recognize a screen 510 corresponding to the news image by using the OCR method. Then, the controller 420 may determine the news image as the first-type image based on detected subtitles 511 or a partial image 512 regarding the news.

When the source image is a movie content image, the controller 420 may determine that the movie content image, which is the source image, is the first-type image, based on a type of an application or a providing device that provides the source image such as a movie content-providing server, a movie play application, etc.

Referring to FIG. 5, the source image may be a sports game image. An illustrated screen 550 may be one scene of a sports game. In this case, the controller 420 may recognize players 551 and 552, which are objects included on the screen through screen recognition such as OCR, ACR, etc., and determine the source image as a sports game image based on the recognized players 551 and 552.

The controller 420 may recognize a genre of the source image by using metadata, electronic program guide (EPG) information of the source image, etc. Herein, the genre may mean a genre of content, and may include news, a lifestyle, a film, a sport, music, children, infants, etc.

When the source image is a sports game image, the controller 420 may determine the genre of the source image as ‘sports’ based on metadata and/or EPG of sports game image data. When the source image is a sports game image, the controller 420 has to recognize flows of the game through the entire screen and thus may determine the source image as the first-type image that needs to be entirely output.

In another example, when genre information included in the first information is music, an output music source of a music play image is important and a corresponding image is mostly incidental. Thus, except for a case where the genre is classified as ‘movie+music’, like music video, etc., the source image corresponding to the music genre may be determined or classified as the second-type image that is partially displayable.

The controller 420 may divide the source image into certain units and determine whether the source image is the first-type image or the second-type image for each certain unit. Herein, the certain unit may be a frame, a scene, a group of pictures (GoP), etc. The controller 420 may control the entire image or a partial image of the source image to be output to an irregular display region of the display 430 based on a result of classification performed for each unit (a result of classification as the first-type image or the second-type image).

The controller 420 may determine whether the source image is the first-type image or the second-type image at certain time intervals. Content output through the display apparatus 400 may be continuously changed over time. Thus, the controller 420 may repeatedly perform an operation of determining whether the source image is the first-type image or the second-type image at certain time intervals.

The controller 420 may convert the source image into a display image, based on the first information, an aspect ratio of the source image, and an aspect ratio of an image outputtable on the display 430. Herein, the display image may mean an image output on the irregular display region of the display 430. Referring to FIG. 2, in Case 1, the display image may be a screen output on the irregular display region 220. That is, the display image may have an oval form in Case 1 of FIG. 2, and the display image may have a rectangular form identical to the source image 210 in Case 2 of FIG. 2.

More specifically, the controller 420 may generate the display image by changing at least one of an aspect ratio of the source image, an image scale, a form of the source image, or a resolution of the source image. For example, when the resolution of the source image is 720*480 and the resolution of the display 430 is 1280*720, the controller 420 may generate the display image by performing upscaling or aspect ratio change on the source image.

The controller 420 may internally include a GPU (not shown) for graphically processing an image to perform image conversion.

The aspect ratio of the source image is an aspect ratio value the source image has inherently, and may be a value determined previously. For example, the aspect ratio of the source image input to the display apparatus 400 may have a value of 4:3 or 16:9.

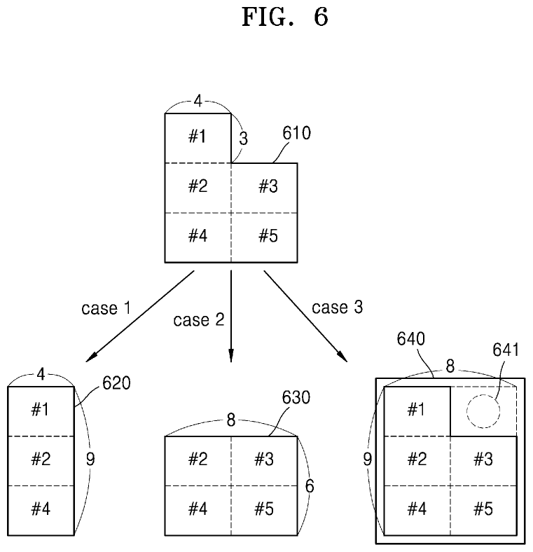

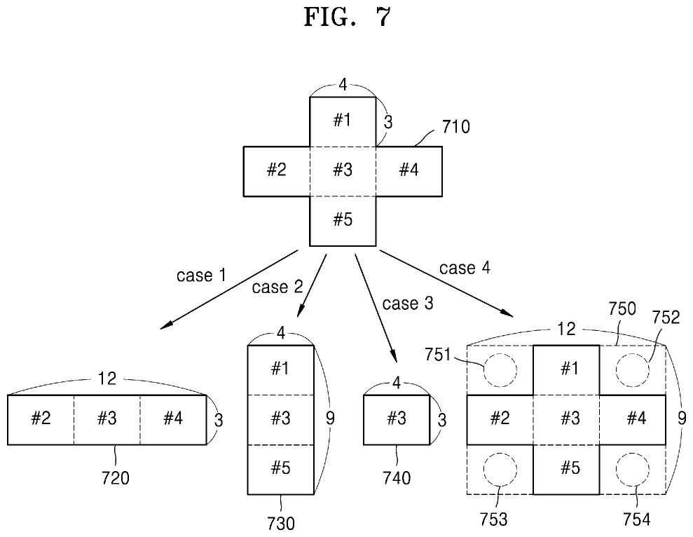

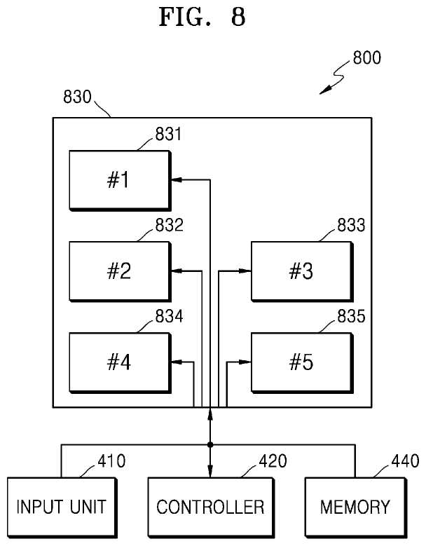

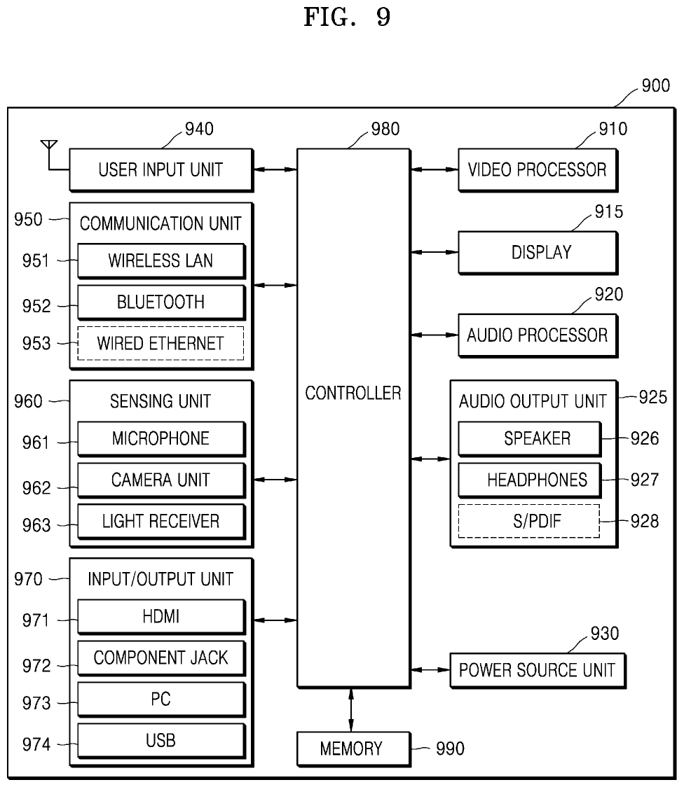

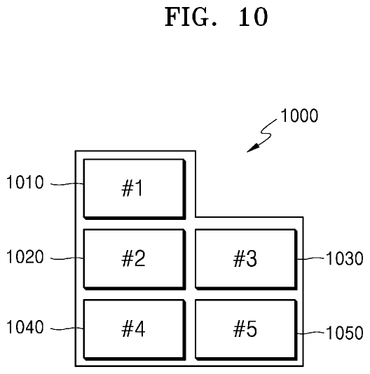

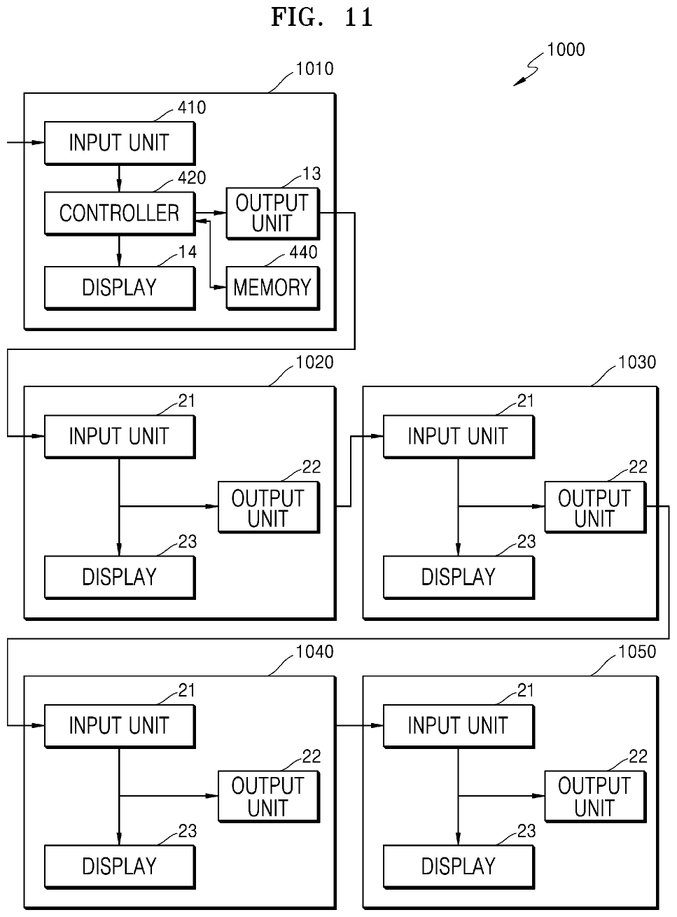

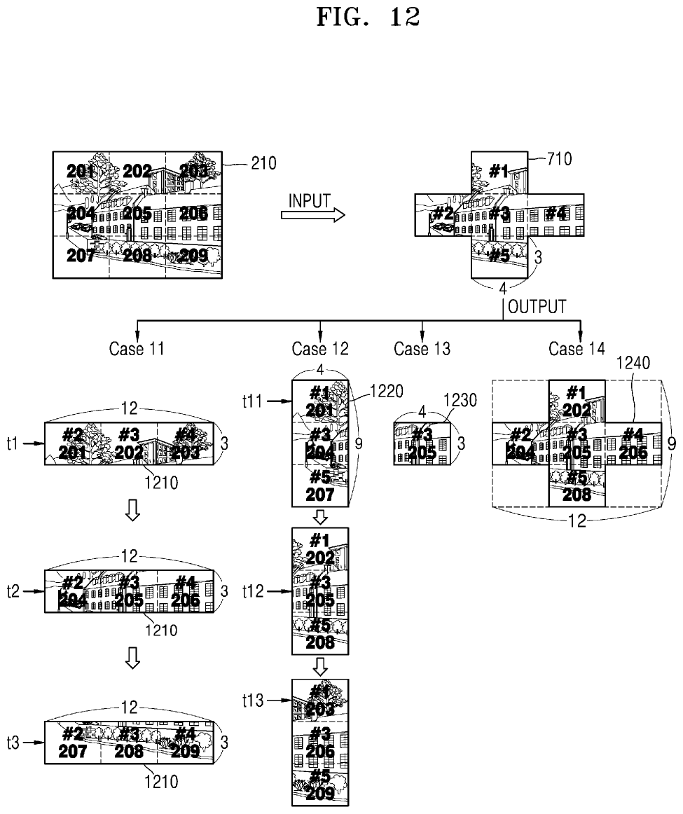

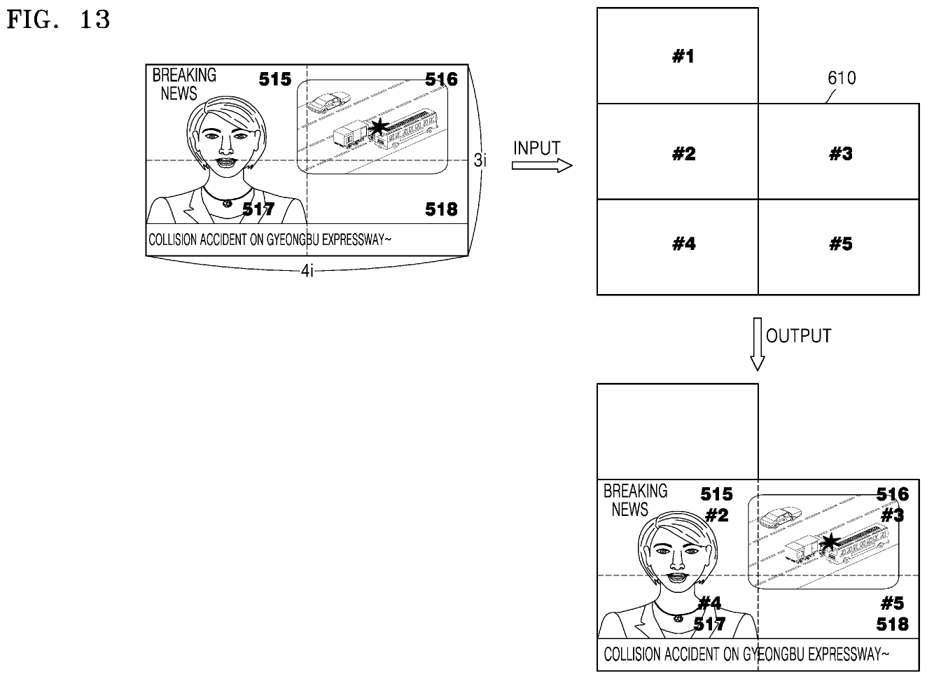

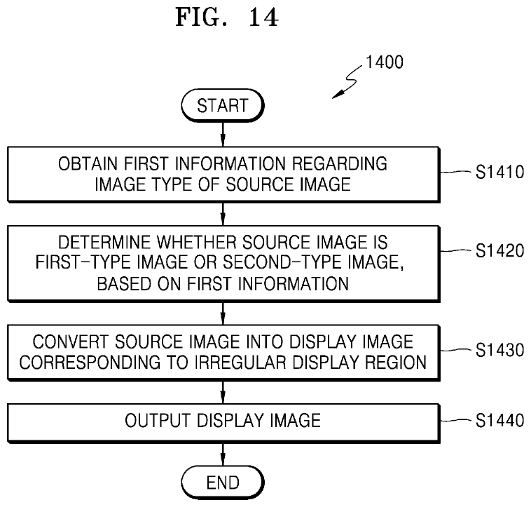

The aspect ratio of the image outputtable on the display 430 will be described below in detail with reference to FIGS. 6 and 7.

FIG. 6 is a view for describing an aspect ratio of an image outputtable on a display having an irregular display region.

Referring to FIG. 6, the display 430 may have a form corresponding to the irregular display region 310 illustrated in FIG. 3. That is, the display 430 may have a display region 610.

FIG. 6 illustrates, as an example, a case where one display 430 is formed by combining five unit displays physically separated. In the example illustrated in FIG. 6, one unit display has an aspect ratio of 4:3. In FIG. 6, the five unit displays are marked with #1, #2, #3, #4, and #5, respectively.

When the display 430 has an irregular display region 610, an aspect ratio of an image outputtable on the irregular display region 610 may correspond to Case 1, Case 2, Case 3, etc.

Referring to Case 1, when the image is output on a region 620 formed of the unit displays #1, #2, and #5, the aspect ratio of the image output on the region 620 may be 4:12.

Referring to Case 2, when the image is output on a region 630 formed of the unit displays #2, #3, #4, and #5, the aspect ratio of the image output on the region 630 may be 8:6 (or 4:3).

Referring to Case 3, when the image is output on a region 640 formed of the unit displays #1, #2, #3, #4, and #5, the aspect ratio of the image output on the region 640 may be 8:9.

Although not shown in FIG. 6, a region formed of the unit displays #3 and #5, a region formed of the unit displays #2 and #3, etc., may further exist.

More specifically, when the source image is the first-type image, the controller 420 may convert the source image into the display image such that the source image is entirely included in the irregular display region of the display 430.

To be more specific, when the source image is the first-type image, the controller 420 may generate a display image by changing a size and an aspect ratio of the source image to fit for a size and an aspect ratio of an image outputtable on the display 430. Herein, a size change may mean a scaling operation of increasing or reducing a magnification or a scale of an image.

For example, when the source image is the first-type image and the aspect ratio of the source image is 4:3, the controller 420 may control the source image to be output on the display 430 without causing generation of a reproduction image loss region, because the source image has to be entirely displayed. Thus, output corresponding to Case 1 and Case 2 where image loss does not occur may be considered. The controller 420 may control an image to be output at an aspect ratio that is the same as or similar to the aspect ratio of the source image. Thus, between Case 1 and Case 2 of FIG. 6, the controller 420 may also convert the source image into the display image to output the source image on the region 630 like in Case 2 with the same aspect ratio as the aspect ratio of the source image.

When the source image is the second-type image, the controller 420 may convert the source image into the display image such that a part of the source image is included in the irregular display region of the display 430. When the source image is the second-type image, the controller 420 may generate the display image having the aspect ratio that maximizes display use efficiency among the aspect ratios of an image outputtable on the display 430. Alternatively, the controller 420 may generate the display image having the aspect ratio corresponding to the aspect ratio of the source image while maximizing display use efficiency among the aspect ratios of an image outputtable on the display 430.

When an image is output through the display 430 having an irregular display region, the displayed image has an irregular form. Thus, the user may feel aesthetic sensibility or interest in comparison to when the user views the image through a uniform rectangular display. Therefore, according to an embodiment of the present disclosure, when the source image is the second-type image, a user's satisfaction may be improved by including a part of the source image in the irregular display region of the display 430.

For example, when the source image is the second-type image and has an aspect ratio of 4:3, loss of a partial region of the source image may be no problem, such that in this case, the controller 420 may convert the source image into a display image to avoid a display use loss region by improving display use efficiency among the aspect ratios of an image outputtable on the display 430. More specifically, the controller 420 may control the display region corresponding to the region 640 to be output as in Case 3 of FIG. 6. In this case, an image of a region corresponding to a region 641 in the source image may have image loss. However, the second-type image, even with image loss, may not cause the user to feel uncomfortable in watching the image. In the above-described case, a region of the display 430 where a black screen is output (a region where the source image is not output) may be minimized, thereby maximizing the use efficiency of the display 430.

FIG. 7 is another view for describing an aspect ratio of an image outputtable on a display having an irregular display region.

Referring to FIG. 7, the display 430 may include a cross-form display region 710.

FIG. 7 illustrates, as an example, a case where one display 430 is formed by combining five unit displays physically separated. In the example illustrated in FIG. 7, one unit display has an aspect ratio of 4:3. In FIG. 7, the five unit displays are marked with #1, #2, #3, #4, and #5, respectively.

When the display 430 has an irregular display region 710, an aspect ratio of an image outputtable on the irregular display region 710 may correspond to Case 1, Case 2, Case 3, Case 4, etc.

Referring to Case 1, when the image is output on a region 720 formed of the unit displays #2, #3, and #4, the aspect ratio of the image output on the region 720 may be 12:3.

Referring to Case 2, when the image is output on a region 730 formed of the unit displays #1, #3, and #5, the aspect ratio of the image output on the region 730 may be 4:9.

Referring to Case 3, when the image is output on a region 740 formed of the unit display #3, the aspect ratio of the image output on the region 740 may be 4:3.

Referring to Case 4, when the image is output on a region 750 formed of the unit displays #1, #2, #3, #4, and #5, the aspect ratio of the image output on the region 750 may be 12:9 (or 4:3).

Although not shown in FIG, 7, there may further exist a region formed of the unit displays #1, #2, and #3, a region formed of the unit displays #2, #3, and #5, a region formed of the unit displays #1, #3, and #4, a region formed of the unit displays #3, #4, and #5, a region formed of the unit displays #1, #2, #3, and #4, etc.

Referring to FIG. 7, when the source image is the first-type image having an aspect ratio of 4:3, to display the source image without any loss, the controller 420 may convert the source image into a square display region identically to the source image. That is, when the source image is the first-type image, the aspect ratios corresponding to Case 1, Case 2, and Case 3 may be considered as the aspect ratio of the display image. For the display image having the aspect ratio that is the most identical or similar to the aspect ratio of the source image, the controller 420 may generate the display image having the aspect ratio corresponding to Case 3 among such cases.

Thus, in an embodiment of the present disclosure, the controller 420 may perform image conversion based on the aspect ratios of an image outputtable on the display 430 when the controller 420 converts the source image into the display image to display the display image.

The controller 420 may also control the aspect ratio of the display image to be changed over time. More specifically, the controller 420 may generate the display image to output an interesting image by avoiding the monotony of image outputting.

To be more specific, for a certain source image, when there are a plurality of aspect ratios of an image outputtable on the display 430, the controller 420 may generate the display image to continuously change the aspect ratio of the image over time.

For example, referring to FIG. 7, when the source image is the first-type image, the aspect ratios corresponding to Case 1, Case 2, and Case 3 may be considered as the aspect ratio of the display image. In this case, to convert the source image into the display image, the controller 420 may control the aspect ratio of the display image to be changed into the aspect ratios corresponding to Case 1, Case 2, and Case 3 at certain time intervals.

More specifically, when the source image is the second-type image, the controller 420 may convert the source image into the display image based on the aspect ratio of the source image and the aspect ratios of an image outputtable on the display 430, such that a part of the source image is not included and some other part of the source image is included in the irregular display region. More specifically, the controller 420 may map the source image to a display region that outputs the display image, according to a form or structure of the display 430, thereby determining a region included in the source image to be output on each of a plurality of displays (e.g., the unit displays #1 through #5) of the display 430. The controller 420 may also control each of the plurality of displays (e.g., the unit displays #1 through #5) to output a part of the source image according to a result of mapping.

FIG. 8 is a block diagram of a display apparatus according to another embodiment of the present disclosure. In a display apparatus 800, the same component as in the display apparatus 400 shown in FIG. 4 is illustrated using the same reference numeral. More specifically, other components and detailed operations of the display apparatus 800 except for a display 830 may be the same as those of the display apparatus 400. Thus, when the display apparatus 800 is described, a description redundant to that made with reference to FIGS. 4 through 7 will not be provided.

Referring to FIG. 8, the display 830 may be a modularized display where a plurality of display panels 831, 832, 833, 834, and 835 physically separated form one display. Herein, a physically separated display panel may be referred to as a unit display panel.

Each of the plurality of display panels 831, 832, 833, 834, and 835 physically separated may receive an image corresponding to a position of each panel in the display image and output the received image, under control of the controller 420. More specifically, the controller 420 may convert the source image into the display image as described above. The controller 420 may divide the converted image into partial regions respectively corresponding to the plurality of display panels 831, 832, 833, 834, and 835 and control the divided partial images to be one-to-one transmitted to and on a corresponding display panel.

More specifically, the controller 420 may generate a partial image corresponding to a certain display panel and transmit the generated partial image to the display panel, by using a frame buffer (not shown) corresponding to each of the plurality of display panels.

FIG. 9 is another block diagram of a display apparatus according to another embodiment of the present disclosure.

Referring to FIG. 9, a display apparatus 900 may include a video processor 910, a display 915, an audio processor 920, an audio output unit 925, a power source unit 930, a tuner unit 940, a communication unit 950, a sensing unit 960, an input/output unit 970, a controller 980, and a memory 990.

Herein, the controller 980 may correspond to the controller 420 illustrated in FIG. 4. A combination of at least one of the tuner unit 940, the communication unit 950, or the input/output unit 970 of the display apparatus 900 may correspond to the input unit 410 illustrated in FIG. 4.

The display 915 and the memory 990 illustrated in FIG. 6 may also correspond to the display 430 and the memory 440 illustrated in FIG. 4. The display 915 may correspond to the display 830 illustrated in FIG. 8. Thus, when the display apparatus 900 illustrated in FIG. 9 is described, a description redundant to a description of the display apparatus 400 or 800 according to an embodiment of the present disclosure will be omitted.

The video processor 910 may perform processing on video data received by the display apparatus 900. The video processor 910 may perform various image processing, such as decoding, scaling, noise filtering, frame rate conversion, resolution conversion, etc., on video data.

The controller 980 may receive a recording request for the video data processed by the video processor 910 and encode the video data to store the encoded video data in a memory device (not shown) included in the controller 980 or the memory 990, e.g., RAM (not shown).

The display 915 displays video included in a broadcast signal received through the tuner unit 940 on a screen under control of the controller 980. The display 915 may display contents (e.g., video) input through the communication unit 950 or the input/output unit 970.

The display 915 may output an image stored in the memory 990 under control of the controller 980. The display 915 displays a voice user interface (UI) (including, e.g., a voice command guide) for performing a voice recognition task corresponding to voice recognition or a motion UI (e.g., a user motion guide for motion recognition) for performing a motion recognition task corresponding to motion recognition.

The audio processor 920 may process audio data. The audio processor 920 may perform various processing such as decoding, amplification, noise filtering, etc., on the audio data. Meanwhile, the audio processor 920 may include a plurality of audio processing modules for processing audio corresponding to a plurality of contents.

The audio output unit 925 may output audio included in a broadcast signal received through the tuner unit 940 under control of the controller 980. The audio output unit 925 may output audio (e.g., voice, sound, etc.) input through the communication unit 950 or the input/output unit 970. The audio output unit 925 may output audio stored in the memory 990 under control of the controller 980. The audio output unit 925 may include at least one of a speaker 926, a headphone output terminal 927, or a Sony/Phillips digital interface (S/PDIF) output terminal 928. The audio output unit 925 may include a combination of the speaker 926, the headphone output terminal 927, and the S/PDIF output terminal 928.

The power source unit 930 may supply power, which is input from an external power source, to internal components 910 through 970 of the display apparatus 900, under control of the controller 980. The power source unit 930 may supply power, which is output from one or more batteries (not shown) included in the display apparatus 900, to the internal components 910 through 990, under control of the controller 980.

The tuner unit 940 may select a frequency of a channel the display apparatus 900 is to receive, from among many electric wave components by tuning the frequency through amplification, mixing, resonance, or the like with respect to a broadcasting signal received by wires or wirelessly. The broadcasting signal may include audio, video, and additional information (for example, an electronic program guide (EPG)).

The tuner unit 940 may receive a broadcasting signal in a frequency band corresponding to a channel number (e.g., cable broadcasting #506), based on a user input (e.g., a control signal received from a control device (not shown, e.g., a remote controller), such as a channel number input, a channel up-down input, and a channel input on an EPG screen).

The tuner unit 940 may receive a broadcasting signal from various sources such as terrestrial broadcasting, cable broadcasting, satellite broadcasting, Internet broadcasting, and so forth. The tuner unit 940 may receive a broadcasting signal from a source such as analog broadcasting, digital broadcasting, or the like. The broadcasting signal received through the tuner unit 940 may be decoded (e.g., audio-decoded, video-decoded, or additional-information-decoded) and separated into audio, video, and/or additional information. The separated audio, video, and/or additional information may be stored in the memory 990 under control of the controller 980.

There may be one tuner unit 940 or a plurality of tuner units 940 in the display apparatus 900. According to an embodiment of the present disclosure, when there are a plurality of tuner units 940, a plurality of broadcasting signals may be output on a plurality of partial screens forming a multi-view screen provided in the display 915.

The tuner unit 940 may be implemented as all-in-one with the display apparatus 900 or as a separate device including a tuner unit electrically connected with the display apparatus 900 (e.g., a set-top box (not shown) or a tuner unit (not shown) connected to the input/output unit 970).

The communication unit 950 connects the display apparatus 900 with an external device (e.g., an audio device, etc.) under control of the controller 980. The controller 980 may transmit/receive contents to/from an external device connected through the communication unit 950, download an application from the external device, or browse the web. More specifically, the communication unit 950 may access a network to receive content from an external device (not shown).

As described above, the communication unit 950 may include at least one of a short-range communication module (not shown), a wired communication module (not shown), or a mobile communication module (not shown).

In FIG. 9, a case is illustrated as an example where the communication unit 950 includes one of a wireless local area network (WLAN) 951, a Bluetooth communicator 952, and wired Ethernet 953.

The communication unit 950 may include a module combination including any one or more of the WLAN 951, the Bluetooth communicator 952, and the wired Ethernet 1153. The communication unit 950 may also receive a control signal of a control device (not shown) under control of the controller 980. The control signal may be implemented as a Bluetooth type, a radio frequency (RF) signal type, or a wireless fidelity (WiFi) type.

The communication unit 950 may further include other short-range communications (e.g., near field communication (NFC) (not shown), a separate Bluetooth Low Energy (BLE) module (not shown), etc.) in addition to Bluetooth.

The sensing unit 960 may sense a voice, an image, or an interaction of the user.

A microphone 961 may receive an uttered voice of the user. The microphone 961 may convert the received voice into an electric signal and output the electric signal to the controller 980. The user's voice may include, for example, a voice corresponding to a menu or a function of the display apparatus 900. For example, a recognition range of the microphone 961 may be recommended to fall within a range of about 4 m from the microphone 961 to a user's position, and may vary with the volume of the voice of the user and a surrounding environment (e.g., a speaker sound, a surrounding noise, etc.).

The microphone 961 may be implemented as an integral or separate type with the display apparatus 900. The separated microphone 961 may be electrically connected with the display apparatus 900 through the communication unit 950 or the input/output unit 970.

It would be easily understood by those of ordinary skill in the art that the microphone 961 may be omitted depending on the capabilities or structure of the display apparatus 900.

A camera unit 962 may receive an image (e.g., a continuous frame) corresponding to a user's motion including a gesture in a camera recognition range. For example, the recognition range of the camera unit 962 may be within about 0.1 m-about 5 m from the camera unit 962 to the user. A user motion may include a motion of a part of a body of the user or a part of the user, such as a face, a facial expression, a hand, a fist, a finger, etc., of the user. The camera unit 962 may convert an image received under control of the controller 980 into an electric signal and output the electric signal to the controller 980.

The controller 980 may select a menu displayed on the display apparatus 900 by using a result of the recognition with respect to a received motion or perform control corresponding to the result of the recognition with respect to the received motion. For example, the control may include channel control, volume control, and indicator movement.

The camera unit 962 may include a lens (not shown) and an image sensor (not shown). The camera unit 962 may support optical zoom or digital zoom by using a plurality of lenses and image processing. A recognition range of the camera unit 962 may be set variously according to a camera angle and surrounding environment conditions. When the camera unit 962 includes a plurality of cameras, a three-dimensional (3D) still image or a 3D motion may be received using the plurality of cameras.

The camera unit 962 may be implemented as an integral or separate type with the display apparatus 900. A separate device (not shown) including the separated camera unit 962 may be electrically connected with the display apparatus 900 through the communication unit 950 or the input/output unit 970.

It would be easily understood by those of ordinary skill in the art that the camera unit 962 may be omitted depending on the capabilities or structure of the display apparatus 900.

A light receiver 963 may receive a light signal (including a control signal) received from an external control device (not shown) through a lighting window (not shown) of a bezel of the display 915. The light receiver 963 may receive a light signal corresponding to a user input (e.g., a touch, a press, a touch gesture, a voice, or a motion) from a control device (not shown). A control signal may be extracted from the received light signal under control of the controller 980.

For example, the light receiver 963 may receive a signal corresponding to a pointing position of the control device (not shown) and transmit the received signal to the controller 980. For example, when a UI screen for receiving data or a command from the user through the display 915 is output and the user is to input the data or the command to the display apparatus 900 through the control device (not shown), once the user moves a control device (not shown) while touching a touch pad (not shown) provided on the control device (not shown) by a finger, then the light receiver 963 may receive a signal corresponding to the movement of the control device (not shown) and transmit the signal to the controller 980. The light receiver 963 may also receive a signal indicating press of a button provided on the control device (not shown) and transmit the signal to the controller 980. For example, when the user presses the touch pad (not shown) provided as a button type on the control device (not shown) with a finger, the light receiver 963 may receive a signal indicating the press of the button-type touch pad (not shown) and transmit the signal to the controller 980. For example, the signal corresponding to the press of the button-type touch pad (not shown) may be used as a signal for selecting one of the items.

The input/output unit 970 may receive video (e.g., moving images, etc.), audio (e.g., a voice, music, etc.), and additional information (e.g., an EPG, etc.) from the outside of the display apparatus 900, under control of the controller 980. The input/output unit 970 may include one of a high-definition multimedia interface (HDMI) port 971, a component jack 972, a PC port 973, and a universal serial bus (USB) port 974. The input/output unit 970 may include a combination of the HDMI port 971, the component jack 972, the PC port 973, and the USB port 974.

It would be easily understood by those of ordinary skill in the art that the construction and operation of the input/output unit 970 may be implemented variously according to an embodiment of the present disclosure.

The controller 980 may control an overall operation of the display apparatus 900 and a signal flow among internal components of the display apparatus 900, and process data. The controller 980 may execute an operating system (OS) and various applications stored in the memory 990, when a user input is performed or a preset and stored condition is satisfied.

The controller 980 may include RAM (not shown) that stores a signal or data input from the outside of the display apparatus 900 or is used as a storage region corresponding to various tasks performed in the display apparatus 900, ROM (not shown) having stored therein a control program for controlling the display apparatus 900, and a processor (not shown).

The processor (not shown) may include a graphic processing unit (GPU, not shown) for processing graphics corresponding to video. The processor (not shown) may be implemented as a system on chip (SoC) in which a core (not shown) and a GPU (not shown) are integrated. The processor (not shown) may include a single core, a dual core, a triple core, a quad core, and multiple cores thereof.

The processor (not shown) may also include a plurality of processors. For example, the processor (not shown) may be implemented using a main processor (not shown) and a sub processor (not shown), which operates in a sleep mode.

The graphic processor (not shown) may generate a screen including various objects such as an icon, an image, a text, etc., by using a calculator (not shown) and a renderer (not shown). The calculator may calculate an attribute value such as coordinates, shapes, sizes, colors, etc., of respective objects based on a layout of the screen by using the user's interaction sensed by the sensor (not shown). The renderer may generate a screen of various layouts including an object based on the attribute value calculated by the calculator. The screen generated by the renderer may be displayed in a display region of the display 915.

FIG. 10 is another block diagram of a display apparatus according to another embodiment of the present disclosure.

Referring to FIG. 10, a display apparatus 1000 according to another embodiment of the present disclosure may be formed by coupling a plurality of independent unit display devices that perform control and/or image output independently of each other. That is, the display apparatus 1000 may be a display system including a plurality of display devices.

More specifically, the display apparatus 1000 may be formed to have the irregular display region 610 shown in FIG. 6 by coupling five unit display devices 1010, 1020, 1030, 1040, and 1050 as shown.

FIG. 11 is a block diagram illustrating in detail the display apparatus of FIG. 10. In FIG. 11, the same component as in FIG. 10 is illustrated using the same reference numeral. Thus, a description redundant to that made with reference to FIGS. 4 and 10 will be omitted. In the display apparatus 1000, a component that determines or classifies the source image as the first-type image or the second-type image based on the first information and generates the display image based on a result of the determination or classification is the same as the display apparatus 400, and thus a detailed description thereof will be omitted.

Referring to FIG. 11, the display apparatus 1000 may include a main display device 1010 and at least one auxiliary display devices 1020, 1030, 1040, and 1050.

The main display device 1010 may include the input unit 410, the controller 420, the memory 440, an output unit 13, and a display 14.

According to an embodiment, the input unit 410 of the main display device 1010 may receive image data (more specifically, the source image) from the outside.

According to an embodiment, the controller 420 of the main display device 1010 may generate an image frame (more specifically, the above-described display image) to be displayed on the display apparatus 1000 by processing an image signal, e.g., the received source image. Herein, the image frame may be a display data unit displayed on each of the unit display devices 1010, 1020, 1030, 1040, and 1050 included in the display apparatus 1000 for a certain time (e.g., 0.2 second).

The output unit 13 of the main display device 1010 may transmit a display image corresponding to the source image, which is generated by converting the source image, to the at least one auxiliary display devices 1020, 1030, 1040, and 1050. For example, as illustrated in FIG. 11, the output unit 13 of the main display device 1010 may transmit the image frame (more specifically, the above-described display image) to the first auxiliary display device 1020.

The output unit 13 may include components for transmitting and receiving the image frame to and from the at least one auxiliary display devices 1020, 1030, 1040, and 1050. For example, the output unit 13 of the main display device 1010 may include at least one of a short-range communication module or a wired communication module.

The display 14 of the main display device 1010 may display a region corresponding to the main display device 1010 in the generated image frame (more specifically, the above-described display image), under control of the controller 420.

The display 14 may also include a display panel (not shown) and a display controller (not shown), and display a region of the image frame processed in the main display device 1010.

Each of the plurality of auxiliary display devices 1020, 1030, 1040, and 1050 may include an input unit 21, an output unit 22, and a display 23.

The input unit 21 of the auxiliary display device 1020 may receive the image frame (more specifically, the above-described display image) generated by the main display device 1010. For example, as shown in FIG. 11, a first auxiliary display device 20-1 may receive an image frame from the main display device 1010, and a second auxiliary display device 20-2 may receive the image frame generated by the main display device 1010 from the first auxiliary display device 20-1.

According to an embodiment, the input unit 21 may receive the image frame generated to be displayed in the main display device 1010. Thus, the auxiliary display device 1020, 1030, 1040, or 1050 may not include an image processing component such as the controller 420 of the main display device 1010.

The input unit 21 may include at least one of a short-range communication module (e.g., a wireless LAN, wireless fidelity (WiFi), Bluetooth, NFC, etc.) or a wired communication module (e.g., a pair cable, a coaxial cable, an optical fiber cable, etc.). The input unit 21 may include, but not limited to, a wired communication module.

The input unit 21 may transmit the received image frame to the output unit 22 and the display 23 of the auxiliary display device 1020, 1030, 1040, or 1050.

The output unit 22 of the auxiliary display device 1020, 1030, 1040, or 1050 may transmit the image frame provided from the input unit 21 to another auxiliary display device. For example, as shown in FIG. 11, the first auxiliary display device 1020 may transmit the image frame to the second auxiliary display device 1030, and the second auxiliary display device 1030 may transmit the image frame to the third auxiliary display device 1040. The image frame may be generated by the main display device 1010.

The output unit 22 may include components for transmitting and receiving the image frame to and from another auxiliary display device. For example, the output unit 22 may include at least one of a short-range communication module or a wired communication module.

According to an embodiment, the display 23 of the auxiliary display device 1020, 1030, 1040, or 1050 may display a region corresponding to the auxiliary display device 1020, 1030, 1040, or 1050 in the image frame provided from the input unit 21. For example, the display 23 of each of the first through fourth auxiliary display devices 1020, 1030, 1040, and 1050 may display a region corresponding to each of the first through fourth auxiliary display devices 1020, 1030, 1040, and 1050 in the image frame.

The display 23 may also include a display panel (not shown) and a display controller (not shown), and display a region of the image frame provided from the input unit 21.

FIG. 12 is a view for describing an image output operation according to an embodiment of the present disclosure.

Referring to FIG. 12, the source image 210 described with reference to FIG. 2 may be input as a source image to the display apparatus (e.g., 400) according to the present disclosure, and the display 430 includes the display region 710 in a cross form described with reference to FIG. 7.

A case will be taken as an example where the source image 210, which is the second-type image, is a simple background image output accompanying reproduction of music.

More specifically, when the source image is the second-type image, the controller 420 may convert the source image into the display image based on the aspect ratio of the source image and the aspect ratios of an image outputtable on the display 430, such that a part of the source image is not included and some other part of the source image is included in the irregular display region.

More specifically, the controller 420 may map the source image to a display region that outputs the display image, according to a form or structure of the display 430, thereby determining a region included in the source image to be output on each of a plurality of displays (e.g., the unit displays #1 through #5) of the display 430. The controller 420 may also control each of the plurality of displays (e.g., the unit displays #1 through #5) to output a part of the source image according to a result of mapping.

When the source image is the second-type image, the source image may be an image that needs to be partially displayed. Thus, the controller 420 may map the source image 210 to the display region 710 based on an aspect ratio of the source image and an aspect ratio of an image outputtable on the display 430 such that a part of the source image 210 is displayed through the irregular display region 710. Thus, each of the plurality of displays (e.g., the unit displays #1 through #5) forming the display region 710 may output a part of the source image according to a result of mapping.

In an example shown in FIG. 12, the aspect ratio of the source image 210 may be 4:3, and the aspect ratio of one unit display (e.g., #5) forming the display region 710 may be 4:3.

The aspect ratio of an image outputtable on the display region 710 may include an aspect ratio of 12:3 as in Case 11, an aspect ratio of 4:9 as in Case 12, an aspect ratio of 4:3 as in Case 13, and an aspect ratio of 12:9 (or 4:3) as in Case 14.

The controller 420 may map a part of the source image 210 to the display region 710 to fit for the aspect ratio of an image outputtable on the display region 710.

Referring to Case 11, the controller 420 may output a part of the source image 210 through the display region 1210 formed of the unit displays #2, #3, and #4 such that the display image which is output on the display 430 has an aspect ratio of 12:3. The source image 210 is the second-type image, such that the source image 210 does not need to be entirely displayed. Thus, the controller 420 may map a part of the source image 210 to the display region 1210 to display the image. The source image 210 may be separated into a plurality of partial regions for mapping with the unit display (e.g., #5). For example, the source image 210 may be separated or divided into nine partial regions 201 through 209.

The controller 420 may map the regions 201, 202, and 203 to the unit displays #2, #3, and #4, respectively. Thus, the unit display #2 may output the region 201 of the source image 210, the unit display #3 may output the region 202 of the source image 210, and the unit display #4 may output the region 203 of the source image 210.

The controller 420 may change the source image 210 output on the display region 1210 over time to allow the viewer to feel aesthetic sensibility and/or interest. More specifically, the controller 420 may map the regions 201, 202, and 203 to the unit displays #2, #3, and #4 of the source image 210, respectively, at a time point t1. The controller 420 may map the regions 204, 205, and 206 to the unit displays #2, #3, and #4 of the source image 210, respectively, at a time point t2 following the time point t1. The controller 420 may map the regions 207, 208, and 209 to the unit displays #2, #3, and #4 of the source image 210, respectively, at a time point t3 following the time point t2. When the source image 210 is output as described above, the viewer may watch the image like when the eyes move from the top row to the bottom row of the source image 210. Thus, the user may not be bored by watching an image changing over time.

Referring to Case 12, the controller 420 may output a part (e.g., the regions 201, 204, and 207) of the source image 210 through a display region 1220 formed of the unit displays #1, #3, and #5 such that the display image which is output on the display 430 has an aspect ratio of 4:9.

The controller 430 may change the source image 210 output on the display region 1220 over time as described in Case 13. More specifically, the controller 420 may map the regions 201, 204, and 207 of the source image 210 to the unit displays #1, #3, and #5, respectively, at a time point t11. The controller 420 may map the regions 202, 205, and 208 of the source image 210 to the unit displays #1, #3, and #5, respectively, at a time point t12 following the time point t11. The controller 420 may map the regions 203, 206, and 209 of the source image 210 to the unit displays #1, #3, and #5, respectively, at a time point t13 following the time point t12. When the source image 210 is output as described above, the viewer may watch the image as when the eyes move from the left column to the right column of the source image 210.

Referring to Case 13, the controller 420 may output a part (e.g., the region 205) of the source image 210 through a display region 1230 formed of the unit display #3 such that the display image which is output on the display 430 has an aspect ratio of 4:3. The controller 420 may control the regions 201 through 209 to be sequentially output through the display region 1230 over time.

Referring to Case 13, the controller 420 may output a part of the source image 210 through the entire display region 1240 of the display 430. More specifically, the controller 420 may map the regions 202, 204, 205, 206, and 208 of the source image 210 to the unit displays #1, #2, #3, #4, and #5, respectively.

FIG. 13 is another view for describing an image output operation according to an embodiment of the present disclosure.

Referring to FIG. 13, a source image 510 described with reference to FIG. 5 may be input as a source image to the display apparatus (e.g., 400) according to the present disclosure, and the display 430 includes the display region 610 in a cross form described with reference to FIG. 6. The source image 510, which is a news image, may be the first-type image.

More specifically, when the source image is the first-type image, the controller 420 may convert the source image into the display image based on the aspect ratio of the source image and the aspect ratios of an image outputtable on the display 430, such that the source image is entirely displayed on the irregular display region 610.

More specifically, the controller 420 may map the source image to a display region that outputs the display image, according to a form or structure of the display 430, thereby determining a region included in the source image to be output on each of a plurality of displays (e.g., the unit displays #1 through #5) of the display 430.

More specifically, the controller 420 may map the regions 515, 516, 517, and 518 of the source image 510 to the unit displays #610, #2, #3, #4, and #5, respectively, such that the source image 510 is entirely displayed on the display region 610.

FIG. 14 is a flowchart of an image display method according to an embodiment of the present disclosure.

FIG. 14 shows a flow of operations performed in a display apparatus according to an embodiment of the present disclosure described with reference to FIGS. 11 through 11.

An image display method 1200 according to an embodiment of the present disclosure may be performed by the display apparatuses 400, 800, 900, or 1000 according to an embodiment of the present disclosure described with reference to FIGS. 1 through 11, and operations performed by the display apparatus 400, 800, 900, or 1000 may correspond to operations included in the image display method 1200. Thus, when the image display method 1200 is described, a description redundant to that made with reference to FIGS. 1 through 11 will not be provided. As an entity of each operation illustrated in FIG. 14, the display apparatus 400 shown in FIG. 4 will be described for reference.

The image display method 1200, which is a method of controlling the display apparatus 600 including the input unit 410, the controller 420, the display 430, and the memory 440, may output an image through a display having an irregular display region.

Referring to FIG. 14, the image display method 1200 may include obtaining first information about an image type of a source image, in operation S1410. Operation S1410 may be performed by the controller 420.

The image display method 1200 may include determining, based on the first information obtained in operation S1410, whether the source image is a first-type image that has to be entirely displayed or a second-type image that is partially displayable, in operation S1420. Operation S1420 may be performed by the controller 420.

The image display method 1200 may converting the source image into a display image corresponding to the irregular display region of the display 430 based on the determination of operation S1420, in operation S1430. Operation S1430 may be performed by the controller 420.

The controller 420 may also control the display image generated in operation S1430 to be output through the display 430, in operation S1440. Operation S1440 may be performed by the controller 420.

The image display method of the display apparatus according to an embodiment or another embodiment of the present disclosure may be implemented in the form of a program command that is executable through various computer means, and may be recorded in a computer-readable medium. In addition, an embodiment of the present disclosure may include a computer-readable recording medium having recorded thereon one or more programs including instructions for executing the image display method of the display apparatus described above.

The computer-readable recording medium may include a program command, a data file, a data structure and the like solely or in a combined manner. The program command recorded in the computer-readable recording medium may be a program command specially designed and configured for the disclosure or a program command known to be used by those skilled in the art of the computer software field. Examples of the computer-readable recording medium may include magnetic media such as hard disk, floppy disk, and magnetic tape, optical media such as compact disk read only memory (CD-ROM) and digital versatile disk (DVD), magneto-optical media such as floptical disk, and a hardware device especially configured to store and execute a program command, such as read only memory (ROM), random access memory (RAM) and flash memory, etc. Examples of the program instructions include a machine language code created by a complier and a high-level language code executable by a computer using an interpreter.

In addition, an image display method of a display apparatus according to an embodiment or another embodiment of the present disclosure described above may be implemented by a computer program product including a recording medium having stored therein a program for performing operations of obtaining a sentence composed in multiple languages, obtaining vectors respectively corresponding to words included in the sentence composed in the multiple languages, transforming the obtained vectors into vectors corresponding to a target language, and obtaining a sentence composed in the target language based on the transformed vectors.

While the present disclosure has been shown and described with reference to certain example embodiments thereof, the scope of the present disclosure is not limited to the description and also includes various modifications and improvements made by those of ordinary skill in the art using the concept of the present disclosure defined in the appended claims.

1. A method of outputting an image through a display comprising an irregular display region, the method comprising:
obtaining first information regarding an image type of a source image;
determining, based on the first information, whether the source image is a first-type image that has to be entirely displayed or a second-type image that is partially displayable;
converting the source image into a display image corresponding to the irregular display region, based on the determining; and
outputting the display image through the display.

2. The method of claim 1, wherein the first information comprises at least one of screen analysis of the source image, a type of an application or providing device that provides the source image, a content type of the source image, or an image genre of the source image.

3. The method of claim 1, wherein the converting comprises converting the source image into the display image, based on the first information, an aspect ratio of the source image, and an aspect ratio of an image that is outputtable on the display.

4. The method of claim 1, wherein the determining comprises dividing the source image into certain units and determining whether the source image is the first-type image or the second-type image for each of the certain units.

5. The method of claim 1, wherein the determining comprises determining whether the source image is the first-type image or the second-type image at certain time intervals.

6. The method of claim 1, wherein the converting comprises converting the source image into the display image such that the entire source image is included in the irregular display region, when the source image is the first-type image.

7. The method of claim 6, wherein the converting comprises generating the display image by changing a size and an aspect ratio of the source image appropriately for a size and an aspect ratio outputtable on the display, when the source image is the first-type image.

8. The method of claim 1, wherein the converting comprises converting the source image into the display image such that a part of the source image is included in the irregular display region, when the source image is the second-type image.

9. The method of claim 1, wherein the determining comprises determining the source image as the first-type image based on the first information, when the source image is an image for providing information comprising a text to a user.

10. The method of claim 1, wherein the determining comprises determining the source image as the second-type image based on the first information, when the source image is an advertisement image.

11. A display apparatus comprising:
an input unit;
a display comprising an irregular display region;
a memory storing at least one instruction; and
a controller comprising at least one processor configured to execute at least one of the at least one instruction,
wherein the controller is configured to:
obtain first information regarding an image type of a source image, determine, based on the first information, whether the source image is a first-type image that has to be entirely displayed or a second-type image that is partially displayable, convert the source image into a display image corresponding to the irregular display region, based on the determining, and control the display image to be output through the display.

12. The display apparatus of claim 11, wherein the controller is further configured to convert the source image into the display image based on the first information, an aspect ratio of the source image, and an aspect ratio of an image that is outputtable on the display.

13. The display apparatus of claim 11, wherein the controller is further configured to determine whether the source image is the first-type image or the second-type image at certain time intervals.

14. The display apparatus of claim 11, wherein the controller is further configured to convert the source image into the display image such that the entire source image is included in the irregular display region, when the source image is the first-type image.

15. The display apparatus of claim 11, wherein the controller is further configured to convert the source image into the display image such that a part of the source image is included in the irregular display region, when the source image is the second-type image.
